(19) United States
(12) Patent Application Publication
(10) Pub. No.: US 2013/0075026 A1
(43) Pub. Date: Mar. 28, 2013

(54) METHOD FOR BONDING PLASTIC MOLD MEMBER ONTO METAL HOUSING

(71) Applicants: Yu-Chih Chang, Taoyuan (TW); Shih-Pu Yu, Taoyuan (TW); Chang-Li Liu, Taoyuan (TW)

(72) Inventors: Yu-Chih Chang, Taoyuan (TW); Shih-Pu Yu, Taoyuan (TW); Chang-Li Liu, Taoyuan (TW)

(21) Appl. No.: 13/447,280

(22) Filed: Apr. 15, 2012

(30) Foreign Application Priority Data
Sep. 27, 2011 (TW) 100134781

(51) Int. Cl. B29C 45/14

(52) U.S. Cl. 156/245

(57) ABSTRACT

A method for bonding a plastic member onto a metal housing is provided. A metal housing having an inner surface and an outer surface is prepared. The inner surface of the metal housing is subjected to physical processing to thereby form a bonding area. An adhesive layer is formed on the bonding area. A plastic mold member is formed on the adhesive layer by plastic injection molding.

### BACKGROUND OF THE INVENTION

1. Field of the Invention

The present invention relates to a method for fabricating a metal-plastic composite body, and more particularly, to a method for bonding plastic mold members onto a metal housing.

2. Description of the Prior Art

In recent years, metal housings with lightweight and high rigidity properties have become more and more necessary since the portable electronic products are developed to be more and lighter, shorter and smaller. In order to follow such requirements, the technology of composite material that combines metal housing with plastic mold members has become a main focus in the industry. The conventional method for fabricating the above-mentioned composite article may comprise the steps of molding the metal piece and the plastic piece separately, applying an adhesive on the metal piece, and then stacking and bonding the metal piece and plastic piece together by pressing. However, the metal housing used in 3C product is usually provided with irregular curved surfaces rather than simple plane structures, and the plastic piece may also have corresponding curved surfaces. It is very difficult for two curved surfaces to bond each other, thereby hindering the yield enhancement.

In relevant prior art, a method for tightly bonding carbon fiber reinforced plastic (CFRP) pre-preg with a metal alloy is disclosed in Japanese Patent Publication No. 2011-73191. Please refer to FIG. 1, the method comprises: roughening predetermined surfaces of CFRP pre-preg 12 and metal alloy 11 first, and applying respectively a one-pack type epoxy adhesive on the roughened surface. Then, the both surfaces covered with the epoxy adhesive are contacted, cured and bonded with each other, wherein a particular chemical agent is necessary for the roughening of the predetermined surface of metal alloy 11 in order to form a surface with nanopores.

A method for fabricating a composite body comprised of metal alloy and thermosetting resin is disclosed in Japanese Patent Publication No. 2010-274600. Please refer to FIG. 2, the method comprises: applying particular chemical agent on a metal alloy body 1 to form a surface with nanopores, and then forming a surface layer made of metal oxide or metal phosphides. Final, forming a plastic member 4 on the surface of metal alloy body 1 by insert injection molding process.

A method of fabricating buttons is disclosed in Japanese Patent Publication No. 2007-179952. The method features the following steps: bonding a metal coating of an outer key top piece and a white coating of an inner key top piece via a fusion layer.

A method for fabricating push-buttons is disclosed in Japanese Patent Publication No. 2009-81030. In this method, the adhesive used for bonding the cover member and key top is applied in dot array between said cover member and said key top in order to facilitate the degassing process during the fabrication.

A metal surface treatment method is disclosed in China Patent Publication No. 1827839. The method comprises: applying a primer first, coating a metal film by vacuum deposition, and then spray a transparent hard film on a metal piece for protection. The purpose of said method is to fabricate the Mg alloy product with a metal texture by surface-treating a raw piece of Mg alloy via vacuum deposition process.

A method of fabricating metal-resin composite articles by injection molding is disclosed in Japanese Patent Publication No. 2011-11505. Please refer to FIG. 3, the resin part 30 is molded on the rear of a metal body 20 and the surface of the metal body 20 is decorated by a decorative sheet F simultaneously with the molding of the resin part 30.

A method of fabricating composite articles is disclosed in Japanese Patent Publication No. 2011-11505. The method comprises: forming a decorative sheet on one surface of a metal body simultaneously with the injection of a molten resin, thereby forming a composite article comprised of the metal body and injected resin in desired mold shape.

Please refer to FIG. 4, a method of fabricating a resin molding equipped with transparent insert material is disclosed in Japanese Patent Publication No. 2011-73314 to provide a resin molding in which strength of a resin part is improved. The method comprises: providing a metallic frame material 4 arranged on the outer periphery of the insert material 3, and sticking an adhesive sheet 5 on the reverse side over the insert material 3 and the frame material 4. A resin part 7 is then formed around the insert material 3 and engaging with at least a part of the periphery 4A of the frame material 4 by injection molding.

### SUMMARY OF THE INVENTION

The main purpose of the present invention is to provide a method for bonding a plastic member onto a metal housing in order to overcome the shortcomings and disadvantages in prior art.

According to one preferred embodiment of the present invention, a method for bonding a plastic member onto a metal housing is provided, comprising the steps of: preparing a metal housing having an inner surface and an outer surface; subjecting the metal housing to a physical processing, thereby forming a bonding area on the inner surface; forming an adhesive layer on the bonding area; and subjecting the metal housing to a plastic injection molding, thereby bonding a plastic mold member on the adhesive layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute a part of this specification. The drawings illustrate some of the embodiments and, together with the description, serve to explain their principles. In the drawings:

FIG. 1 is a schematic view of a carbon fiber reinforced plastic pre-preg tightly bonded to a metal alloy disclosed in Japanese Patent Publication No. 2011-73191.

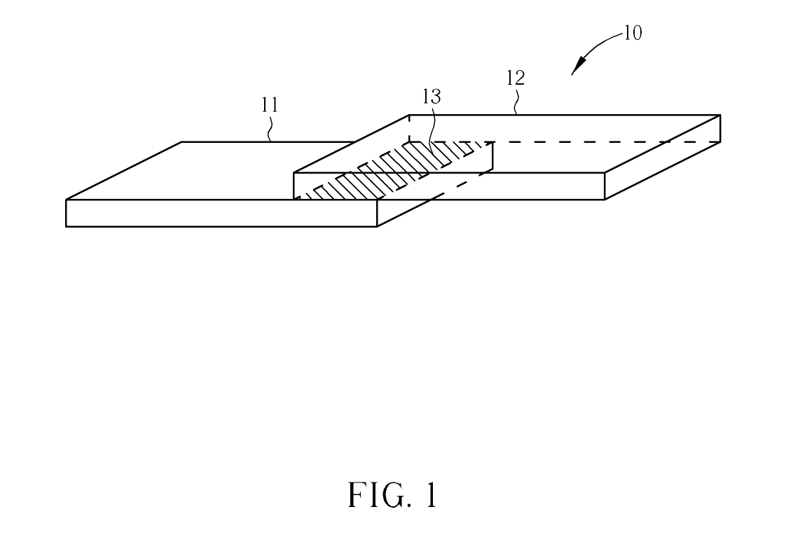

FIG. 2 is a schematic view of a composite comprised of metal alloy and thermosetting resin disclosed in Japanese Patent Publication No. 2010-274600.

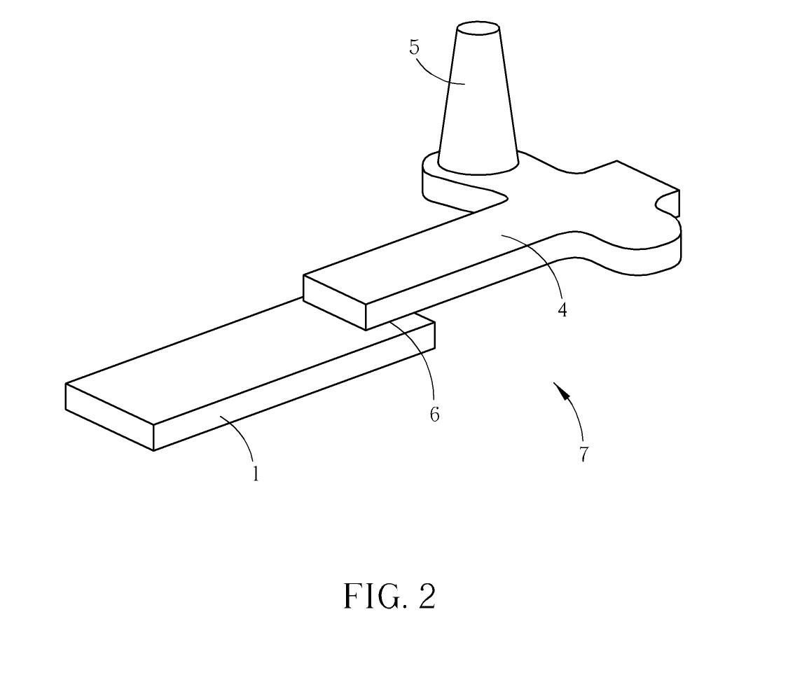

FIG. 3 is a schematic view of a metal-resin composite fabricated by injection molding disclosed in Japanese Patent Publication No. 2011-11505.

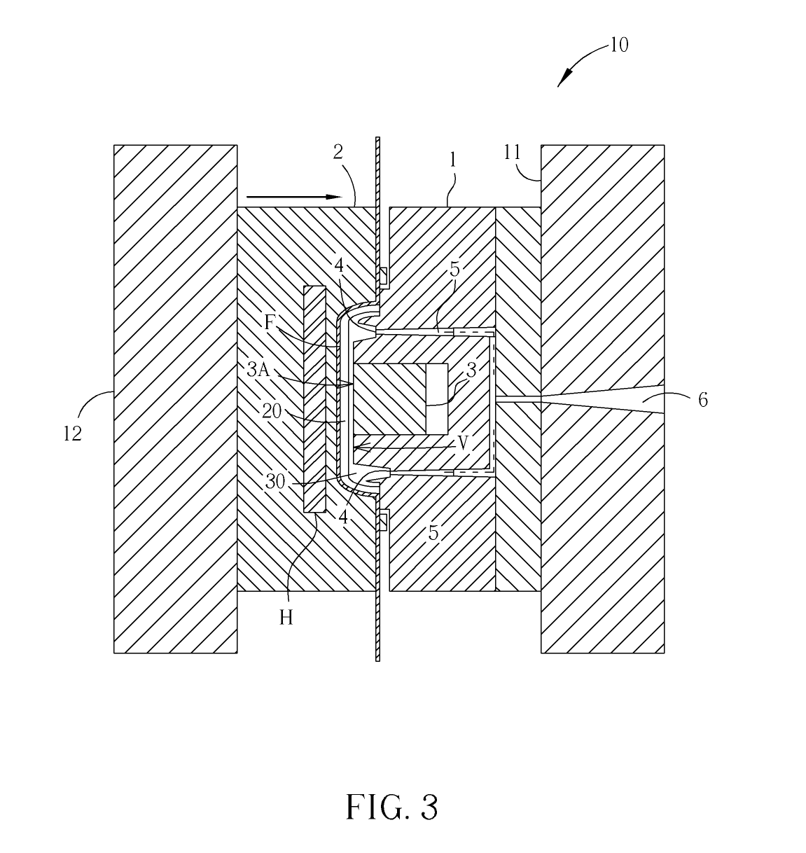

FIG. 4 is a schematic view of a resin molding method using transparent inserting materials disclosed in Japanese Patent Publication No. 2011-73314.

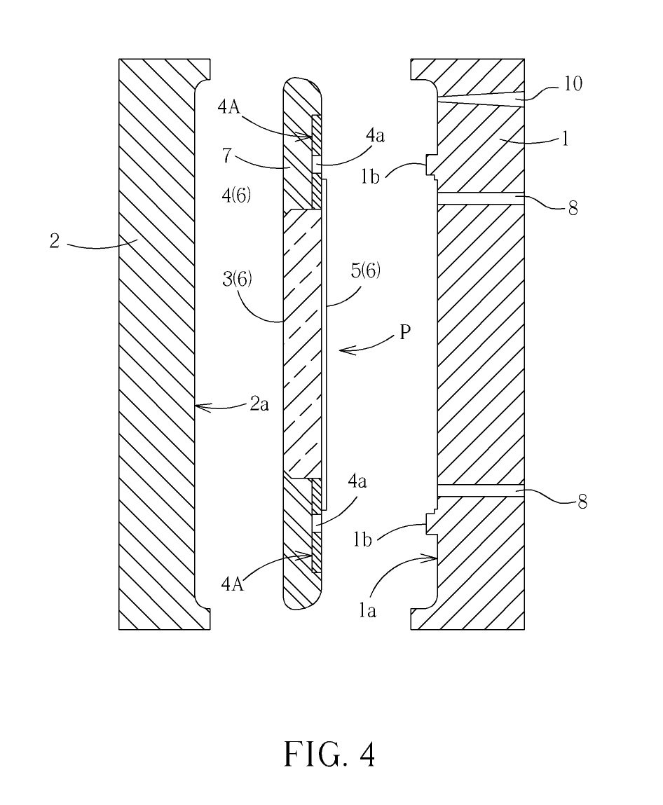

FIG. 5 is a side view of a composite body with plastic members bonded on a metal housing exemplified in the present invention.

FIG. 6 is a cross-sectional view of the composite body with plastic members bonded on a metal housing in FIG. 5 taken along the line I-I′.

FIG. 6A is an enlarged view of the portion in circle of FIG. 6.

FIG. 7 is a flowchart of the method for fabricating a composite body with plastic members bonded onto a metal housing according to one preferred embodiment of the present invention.

FIG. 8 is a flowchart of the method for fabricating a composite body with plastic members bonded onto a metal housing according to another preferred embodiment of the present invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following detailed description of the invention, reference is made to the accompanying drawings which form a part hereof, and in which is shown, by way of illustration, specific embodiments in which the invention may be practiced. These embodiments are described in sufficient detail to enable those skilled in the art to practice the invention. Other embodiments may be utilized and structural, logical, and electrical changes may be made without departing from the scope of the present invention.

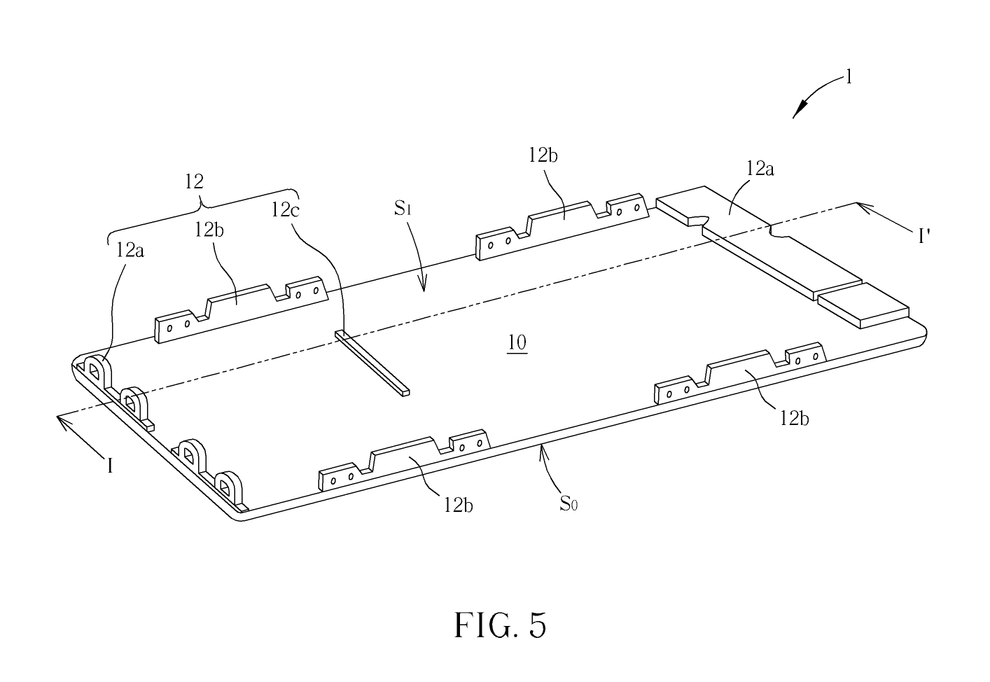

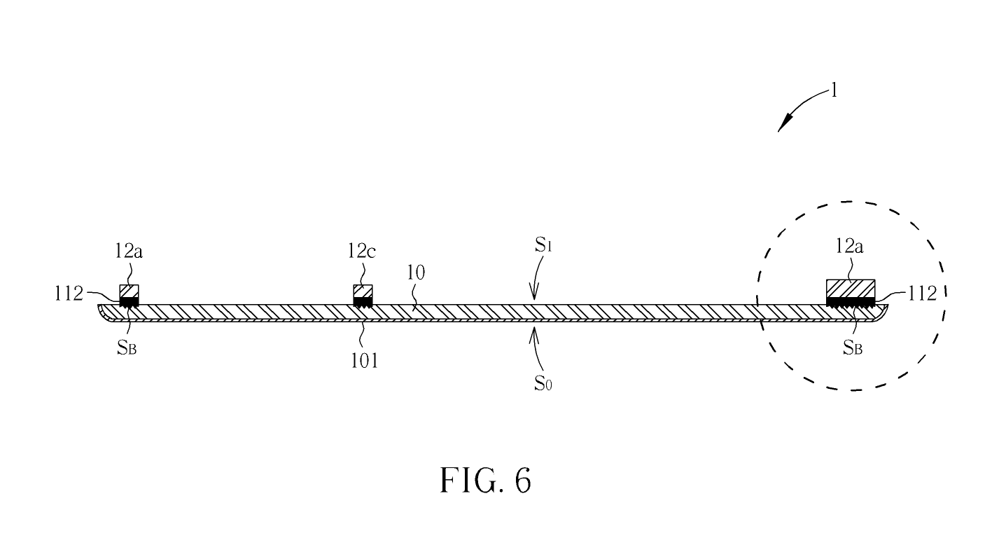

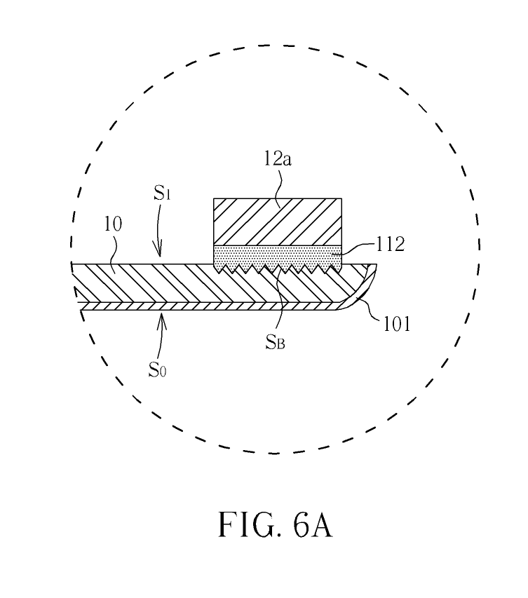

Please refer to FIGS. 5, 6 and 6A, wherein FIG. 5 is a side view of a composite body with plastic members bonded on a metal housing, FIG. 6 is a cross-sectional view of the composite body with plastic members bonded on metal housing in FIG. 5 taken along the line I-I′, and FIG. 6A is an enlarged view of the portion in circle in FIG. 6. The composite body with plastic members bonded on a metal housing may be a cell phone housing or a battery cover. As shown in FIGS. 5 and 6, the composite body 1 with plastic members bonded on a metal housing of the present invention includes a metal housing 10 and a plastic mold member 12 formed on the inner surface S1 of the metal housing 10, wherein the plastic mold member 12 is comprised of input/output jacks 12a, assembly structures 12b and/or reinforcement structures 12c.

The plastic mold member 12 is injection-molded on a bonding area S_{B} in one inner surface S1 of the metal housing 10. To be more specific, the bonding area S_{B} is formed by physical processing or chemical processing before performing the inject-molding of bonding area S_{B}. The plastic mold member 12 is inject-molded on an adhesive layer 112, thereby establishing a tight bonding with the metal housing 10. A decorating layer 101 may also be coated on an outer surface S₀ of the metal housing 10 to render various textures and appearances.

The above-mentioned physical processing for forming the bonding surface S_{B} may include roughening treatment by sandblast, laser etching, plasma treatment, UV plasma treatment, or die pressing, while the chemical processing may include chemical etching and shaping.

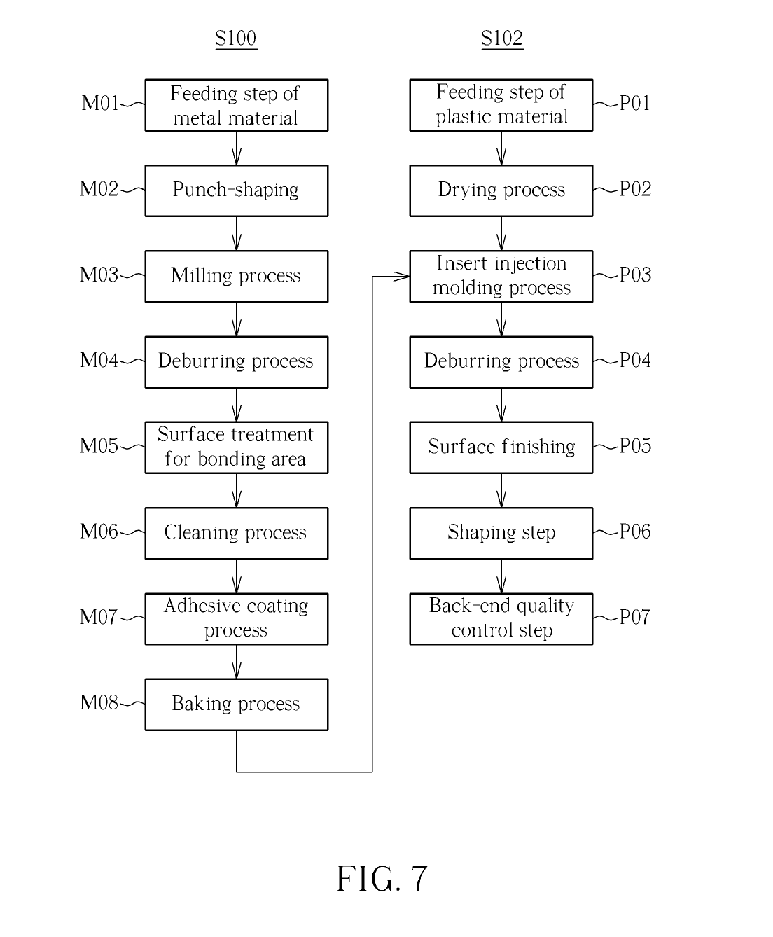

Please refer to FIG. 7, which is a flowchart of the method for fabricating a composite body with plastic members bonded on a metal housing according to one preferred embodiment of the present invention. As shown in FIG. 7, the method for fabricating a composite body with plastic members bonded on a metal housing comprises two sub-flows S100 and S102, wherein the sub-flow S100 is the fabricating flow for the metal housing, while the sub-flow S102 mainly comprises the steps of insert injection molding, surface finishing or treatment, and quality inspection for back-end product. First, a feeding step and an incoming inspection for metal material are performed (step M01), wherein the foregoing metal material may be stainless steel, Mg alloy, Al alloy or Mg—Al alloy. Then, a punch-shaping to obtain the desired shape of metal housing is performed (step M02), wherein the shape can be that of a cell phone housing or a battery cover. Then, a milling process (step M03) and a deburring process (step M04) are performed.

After the deburring process, a bonding area is formed on the inner surface of metal housing (step M05). According to one preferred embodiment of the present invention, the bonding area may be subjected to a surface treatment by physical processing, such as sandblast. Of course, other physical processes, like laser etching, plasma treatment, UV plasma treatment or die molding, may also be utilized to obtain roughened surface. Alternatively, the bonding area may also be formed by chemical processing, such as chemical etching and shaping. Then, a cleaning process (step M06) and a process for coating adhesive (step M07) are performed. The adhesive coating or adhesive bonding primers can be formed on the surface-treated bonding area by a spraying, a dispensing or a printing method to form an adhesive layer on said bonding area. A baking process is finally performed (step M08). This way the sub-flow S100 is completed. The metal housing treated by the sub-flow S100 is ready to undergo the following steps of insert injection molding (i.e. sub-flow S102).

The sub-flow S102 will be described hereinafter. First, a feeding step and an inspection step for a plastic material are performed (step P01), wherein the plastic material may be polycarbonate (PC) resin, acrylonitrile butadiene styrene (ABS) resin or polyphenylene sulfide (PPS) resin, etc. A drying process (step P02) is performed followed by an insert injection molding process to injection-mold the plastic material or plastics on the metal housing treated by sub-flow S100 (step P03). To be more specific, the plastic is injection-molded directly on the adhesive layer in the bonding area of the metal housing. For example, the metal housing can be a cell phone housing or a battery cover, while the injection-molded plastic mold members may be input/output jacks, assembly structures and/or reinforcement structures. Since the insert injection molding is a well-known process, the relevant details are omitted herein for simplicity. Then, perform a deburring process (step P04) and a surface finish step may be optionally carried out (step P05), such as sandblast, hair-line surface treatment, physical vapor deposition (PVD) process, anodic treatment or spray treatment, etc. Please note that the foregoing PVD treatment further includes a Ni-plating process which may provide the special effect of rendering concealed characters on the surface of housing. In addition, a decorating layer may be formed on the outer surface of the metal housing by printing, coating, or anodized aluminum treatment to render various colors, patterns and texture designs. Finally, perform a shaping step (step P06) and a back-end quality control step (step P07), thereby completing the sub-flow S102.

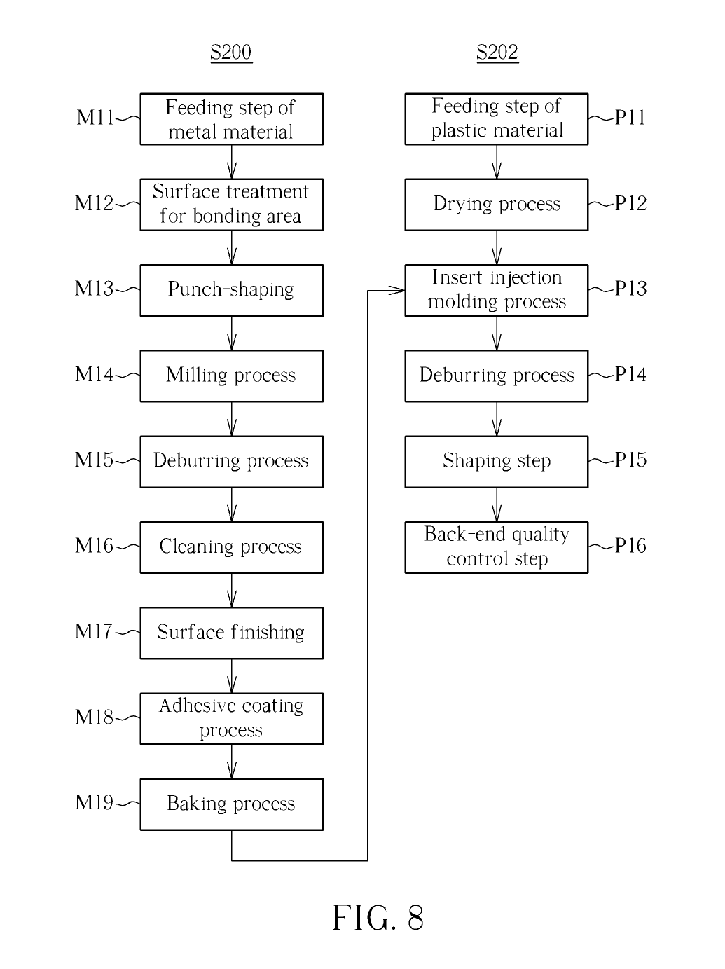

Please refer to FIG. 8, which is a flowchart of the method for fabricating the composite body with plastic members bonded to metal housing according to another preferred embodiment of the present invention. As shown in FIG. 8, the method for fabricating a composite body with plastic members bonded to a metal housing comprises also two sub-flows S200 and S202, wherein the sub-flow S200 is a fabricating flow for the metal housing, while sub-flow S202 mainly comprises the steps of insert injection molding, surface treatment and quality inspection for the back-end product. The sub-flow S202 will be described hereinafter. First, perform a feeding step and an incoming inspection for the metal material (step M11), wherein the metal material may be stainless steel, Mg alloy, Al alloy or Mg—Al alloy, etc. Then, form a bonding area on the inner surface of the metal housing (step M12). According to one preferred embodiment of the present invention, the bonding area may be subjected to a surface roughening treatment by physical processing, such as sandblast. Other physical processes, for example, laser etching, plasma treatment, UV plasma treatment or die molding, may also be utilized to obtain the roughened surface. The bonding area may also be formed by a chemical processing, such as chemical etching and shaping. Then, perform a punch-shaping to obtain desired shape for the metal housing (step M13), such as a cell phone housing or a battery cover shape. Then, perform a milling process (step M14) and a deburring process (step M15). Then, perform a cleaning process (step M16).

After the cleaning process, a surface finish step is then performed (step M17), such as sandblast, hair-line surface treatment, PVD process, anodic treatment or spray treatment, etc. Please note that the foregoing PVD treatment further includes a Ni-plating process which may provide a special effect of rendering the concealed characters on the surface of housing. In addition, a decorating layer may be formed on the outer surface of the metal housing by printing, coating, or anodized aluminum treatment to render various colors, patterns and texture designs. Then, perform a process for coating adhesive (step M18), for example, coating the adhesive or adhesive bonding primers on the surface-treated bonding area by a spraying, a dispensing or a printing method to form an adhesive layer on said bonding area. Then, perform a baking process (step M19), thereby completing the sub-flow S200. The metal housing treated by the sub-flow S200 is ready to undergo the following insert injection molding (i.e. sub-flow S202).

The sub-flow S202 will be described hereinafter. First, perform a feeding step and an inspection step for a plastic material (step P11), wherein the plastic material may be polycarbonate (PC) resin, acrylonitrile butadiene styrene (ABS) resin or polyphenylene sulfide (PPS) resin, etc. Perform a drying process (step P12) and an insert injection molding process (step P13) to inject-mold the plastic material or plastics on the metal housing previously treated by sub-flow S200. To be more specific, the plastic is inject-molded directly on the adhesive layer in the bonding area of the metal housing. For example, the metal housing maybe a cell phone housing or a battery cover, while the injection-molded plastic mold members may be input/output jacks, assembly structures and/or reinforcement structures. Since the insert injection molding is a well-known process, the relevant details are omitted herein for simplicity. Then, perform a deburring process (step P14). Finally, perform a shaping step (step P15) and a back-end quality control step (step P16), thereby completing the sub-flow S202.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for bonding a plastic member onto a metal housing, comprising the steps of:
preparing a metal housing having an inner surface and an outer surface;
subjecting the metal housing to a physical processing, thereby forming a bonding area at the inner surface;
forming an adhesive layer on the bonding area; and
subjecting the metal housing to a plastic injection molding thereby bonding a plastic mold member on the adhesive layer.

2. The method for bonding a plastic member onto a metal housing according to claim 1, wherein the physical processing comprises a roughening treatment by sandblast, laser etching, plasma treatment, UV Plasma treatment, or die pressing.

3. The method for bonding a plastic member onto a metal housing according to claim 1, wherein the adhesive layer is formed by spraying, dispensing, or printing method.

4. The method for bonding a plastic member onto a metal housing according to claim 1, wherein the adhesive layer comprises an adhesive.

5. The method for bonding a plastic member onto a metal housing according to claim 1, wherein the adhesive layer comprises an adhesive bonding primer.

6. The method for bonding a plastic member onto a metal housing according to claim 1, wherein after forming said adhesive layer on the bonding area, performing a baking process.

7. The method for bonding a plastic member onto a metal housing according to claim 1, further comprising a surface finishing step or a surface treatment step.

8. The method for bonding a plastic member onto a metal housing according to claim 1, further comprising:
forming a decorating layer on the outer surface of the metal housing.

9. The method for bonding a plastic member onto a metal housing according to claim 8, wherein the decorating layer is formed by printing, coating or anodized aluminum treatment, thereby rendering colors, patterns or decorative design on the outer surface of the metal housing.

10. A method for bonding a plastic member onto a metal housing, comprising the steps of:
preparing a metal housing having an inner surface and an outer surface;
subjecting the metal housing to a chemical processing, thereby forming a bonding area at the inner surface;
forming an adhesive layer on the bonding area; and
subjecting the metal housing to a plastic injection molding thereby bonding a plastic mold member on the adhesive layer.

11. The method for bonding a plastic member onto a metal housing according to claim 10, wherein the chemical processing comprises chemical etching and shaping.

12. The method for bonding a plastic member onto a metal housing according to claim 10, wherein adhesive layer is formed by a spraying, a dispensing, or a printing method.

13. The method for bonding a plastic member onto a metal housing according to claim 10, wherein the adhesive layer comprises an adhesive.

14. The method for bonding a plastic member onto a metal housing according to claim 10, wherein the adhesive layer comprises an adhesive bonding primer.

15. The method for bonding a plastic member onto a metal housing according to claim 10, wherein a baking process is performed after forming an adhesive layer on the bonding area.

16. The method for bonding a plastic member onto a metal housing according to claim 10, further comprising a surface finish or a surface treatment.

17. The method for bonding a plastic member onto a metal housing according to claim 10, further comprising:
forming a decorating layer on the outer surface of the metal housing.

18. The method for bonding a plastic member onto a metal housing according to claim 17, wherein the decorating layer is formed by printing, coating or anodized aluminum treatment, thereby rendering colors, patterns or decorative design on the outer surface of the metal housing.
